(19) United States
(12) Patent Application Publication
(10) Pub. No.: US 2011/0131862 A1
(43) Pub. Date: Jun. 9, 2011

(54) Fishing Rod Attachment Apparatus

(76) Inventors: Gaetano D. Magarelli, Elizaville, NY (US); Richard A. Wyant, Red Hook, NY (US)

(21) Appl. No.: 12/634,041

(22) Filed: Dec. 9, 2009

(51) Int. Cl. A01K 97/10

(52) U.S. Cl. 43/21.2

(57) ABSTRACT

An apparatus for attaching a fishing rod to a user's person comprises an elongate base which defines a first end, a second end, and a center. A first pair of opposing sidewalls is attached to this elongate base proximate to its first end. In addition, a center sidewall is attached to the elongate base proximate to the base's center and separate from the first pair of opposing sidewalls. An attachment portion is also attached to the elongate base proximate to the center of the elongate base and comprises a clip operative to clasp a belt or a waistband. Lastly, a second pair of opposing sidewalls is attached to the elongate base proximate to its second end and separate from the center sidewall.

### FIELD OF THE INVENTION

The present invention relates generally to equipment for use while fishing, and, more particularly, to apparatus for attaching a fishing rod to a user's belt or waistband.

### BACKGROUND OF THE INVENTION

Many fishermen often wish they had a third arm and hand when handling their fishing rod. Several of the tasks that fishermen routinely perform are difficult to accomplish while simultaneously holding a fishing rod. These tasks include baiting a hook or removing the catch from a hook. For this reason, many fishermen resort to trying to brace their fishing rod between their arms and bodies or between their legs while performing these tasks. Still others resort to putting the fishing rod onto the ground or onto the floor of their boat. Unfortunately, these placements frequently lead to a snagged or tangled line, dirt in the reel mechanism, and even the possibility of having the rod pulled into the water by a hooked fish.

Information relevant to attempts to address these problems can be found in, for example, U.S. Pat. No. 3,874,573 to Fruscella et al.; U.S. Pat. No. 4,739,914 to Pothetes; U.S. Pat. No. 4,896,806 to Sanchez, Jr.; U.S. Pat. No. 5,044,109 to Fast; U.S. Pat. No. 5,105,574 to Fast; U.S. Pat. No. 5,511,336 to Bishop; U.S. Pat. No. 5,992,717 to Clewes et al.; and U.S. Pat. No. 5,813,162 to Tse et al. However, each of these references suffers from one or more disadvantages, including the use of devices that are complex and expensive to manufacture, the use of devices that can only hold rods of a given type (i.e., those with a reel mechanism and those without), and the use of devices that do not hold the rod in a position that allows the user to easily access the hook. For the foregoing reasons, there is a need for an apparatus for attaching a fishing rod to a user's person that addresses these various deficiencies.

### SUMMARY OF THE INVENTION

Embodiments of the present invention address the above-identified need by providing apparatus operative to attach fishing rods to the persons of users. Advantageously, these embodiments are inexpensive to manufacture, can accommodate fishing rods with and without reels, and are operative to hold the fishing rod in a convenient position relative to the user.

In accordance with an aspect of the invention, an apparatus for attaching a fishing rod to a user's person comprises an elongate base which defines a first end, a second end, and a center. A first pair of opposing sidewalls is attached to this elongate base proximate to its first end. In addition, a center sidewall is attached to the elongate base proximate to the base's center and separate from the first pair of opposing sidewalls. An attachment portion is also attached to the elongate base proximate to the center of the elongate base and comprises a clip operative to clasp a belt or a waistband. Lastly, a second pair of opposing sidewalls is attached to the elongate base proximate to its second end and separate from the center sidewall.

In accordance with one of the above-identified embodiments of the invention, the above-described apparatus comprises a single piece of injection molded plastic. The first and second pairs of opposing sidewalls in combination with the elongate base define two collinear partial cylinders in which the fishing rod rests when supported by the apparatus. These partial cylinders have inner diameters that are slightly smaller than the diameter of the handle portion the fishing rod. This choice of dimensions allows the fishing rod to be positioned within the apparatus so that at least one of the pairs of opposing sidewalls places a light clamping pressure on the fishing rod. The light clamping pressure helps to hold the fishing rod more securely within the apparatus. Gaps between the center sidewall and the first and second opposing sidewalls accommodate fishing rods with reels.

### BRIEF DESCRIPTION OF THE DRAWINGS

These and other features, aspects, and advantages of the present invention will become better understood with regard to the following description, appended claims, and accompanying drawings where:

FIG. 1 shows a side view of an apparatus in accordance with an illustrative embodiment of the invention acting to attach a fishing rod to the belt of a user; and

FIG. 2A-2E show a perspective view, a front view, a side view, a top view, and a bottom view, respectively, of the FIG. 1 apparatus.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

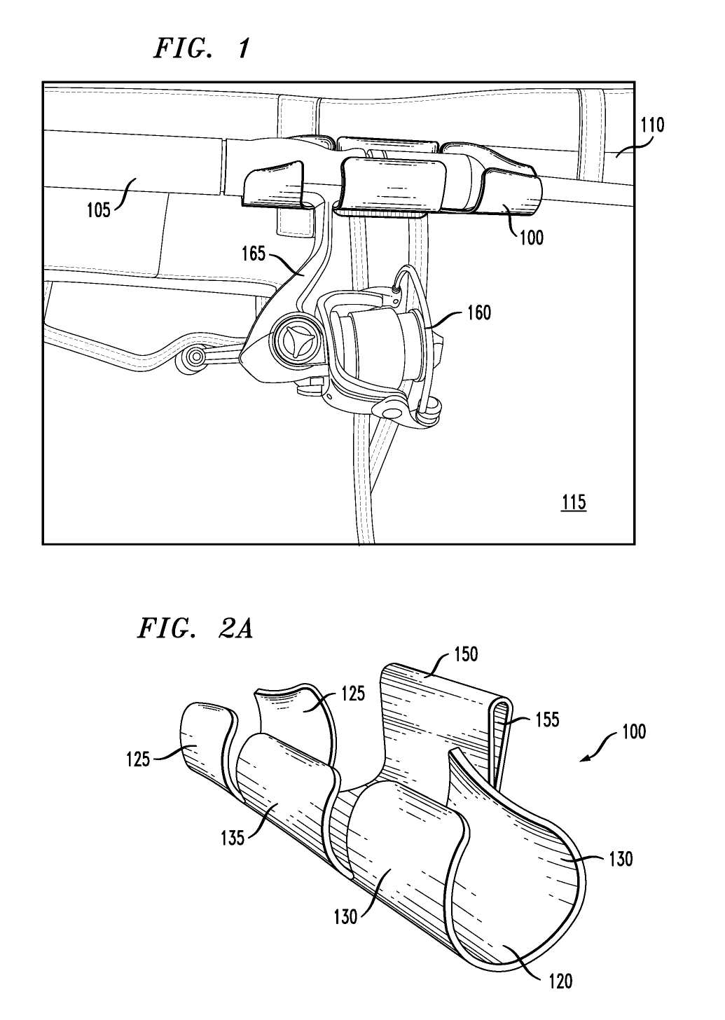

FIG. 1 shows an apparatus 100 in accordance with an illustrative embodiment of the invention. In this figure, the apparatus is shown fulfilling one of its primary purposes, namely, acting to attach a fishing rod 105 to the belt 110 of a user 115. The apparatus acts to hold the fishing rod horizontally with respect to the user's body. This frees up the user's hands so that the user can perform tasks requiring both hands without having to simultaneously brace the fishing rod or put the rod down. It also places the tip of the fishing rod (not shown) in front of the user's body so that the user can easily access the fishing rod's line and hook. The user is then able to conveniently and ergonomically repair the line, bait the hook, replace the hook, remove catch from the hook, and perform other such tasks.

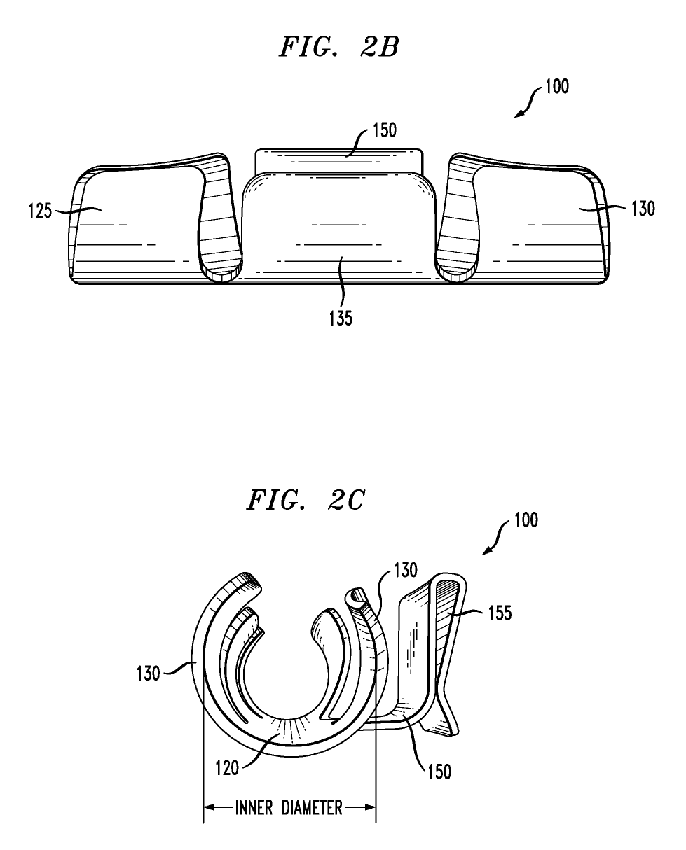

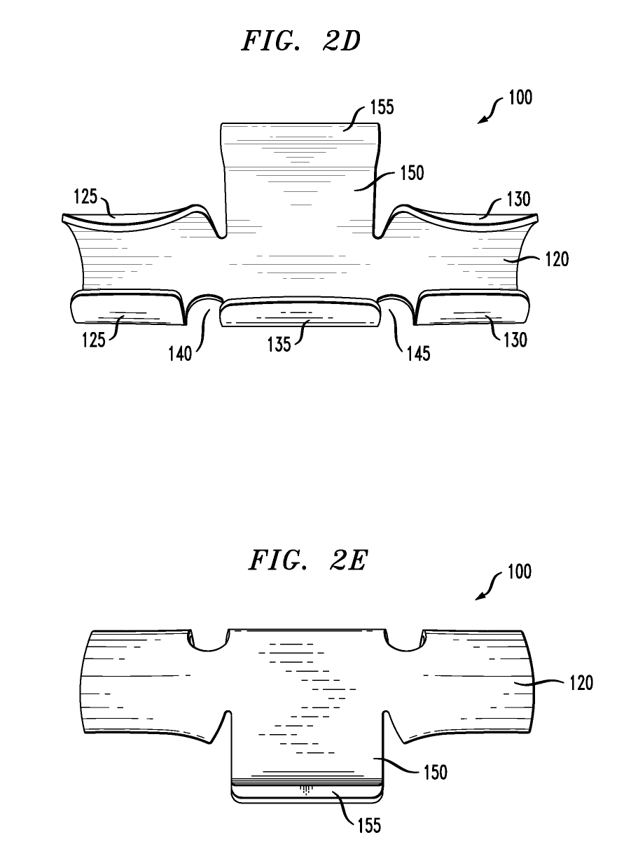

FIGS. 2A-2E show further views of the apparatus 100 itself. More particularly, these figures show a perspective view, a front view, a side view, a top view, and a bottom view, respectively. The apparatus comprises an elongate base 120. A first pair of opposing sidewalls 125 is attached to the base at one of its ends, while a second pair of opposing sidewalls 130 is attached to the base at the opposite end. A center sidewall 135 is attached to the base near its center. The center sidewall is separated from the first and second pairs of opposing sidewalls, thereby defining a first gap 140 and a second gap 145. Lastly, an attachment portion 150 is attached to the base opposite the center sidewall. The attachment portion includes a clip 155 that is operative to clasp a user's waistband or belt.

When viewed end on as in FIG. 2C, it will be noted that the first and second pairs of opposing sidewalls 125, 130 in combination with the elongate base 120 define two substantially collinear partial cylinders in which the fishing rod 105 rests when supported by the apparatus 100. These partial cylinders preferably (although, not necessarily) have inner diameters (as that dimension is defined on FIG. 2C) that are slightly smaller than the diameter of the handle portion of the fishing rod. The partial cylinders may, for example, have inner diameters of about 1.25 inches. This choice of dimensions allows the user to position the fishing rod within the apparatus so that at least one of the pairs of opposing sidewalls places a light clamping pressure on the fishing rod. The light clamping pressure, in turn, helps to hold the fishing rod more securely within the apparatus, while, at the same time, still allows the user to easily remove the fishing rod therefrom.

Advantageously, the apparatus 100 can support fishing rods that have reels as well as fishing rods that do not have reels. In FIG. 1, for example, the fishing rod 105 includes a reel 160 that is attached to the remainder of the fishing rod via a reel support arm 165. When placed in the apparatus, this reel support arm is aligned with the first gap 140 of the apparatus so that the reel and reel support arm are allowed to naturally drop below the remainder of the fishing rod due to gravity. Notably, the second gap allows the apparatus to accommodate the same fishing rod and reel if the apparatus is positioned on the user's opposite hip.

Because it is desired that the apparatus 100 is somewhat flexible, the apparatus is preferably formed of plastic, although other suitable materials (e.g., aluminum) may be utilized. If formed of plastic, the apparatus may, for example, be formed as a single integral piece of thermoplastic or thermosetting plastic by conventional injection molding techniques. Injection molding is a mature manufacturing process that will be familiar to one skilled in the manufacture of plastic parts. Moreover, it is described in detail in several references including, as just one example, G. Pötsch et al., Injection Molding—An Introduction, 2^{nd} Edition, Carl Hanser Verlag, Munich, Germany, 2008, which is hereby incorporated by reference herein. Injection molding of the apparatus makes mass production of the apparatus relatively inexpensive.

It should again be emphasized that the above-described embodiments of the invention are intended to be illustrative only. Other embodiments can use different types and arrangements of elements for implementing the described functionality. For example, rather than using the simple clip 155 described above, a more elaborate belt clip may be utilized such as one that depends on springs to provide the clasping force. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus for attaching a fishing rod to a user's person, the apparatus comprising:
an elongate base, the elongate base defining a first end, a second end, and a center;
a first pair of opposing sidewalls, the first pair of opposing sidewalls attached to the elongate base proximate to the first end;
a center sidewall, the center sidewall attached to the elongate base proximate to the center and separate from the first pair of opposing sidewalls;
an attachment portion, the attachment portion attached to the elongate base proximate to the center and comprising a clip operative to clasp a belt or a waistband; and
a second pair of opposing sidewalls, the second pair of opposing sidewalls attached to the elongate base proximate to the second end and separate from the center sidewall.

2. The apparatus of claim 1, wherein the first pair of opposing sidewalls, the center sidewall, and the second pair of opposing sidewalls run substantially parallel to a longitudinal axis of the elongate base.

3. The apparatus of claim 1, wherein the apparatus comprises a single piece of material.

4. The apparatus of claim 1, wherein the apparatus comprises plastic.

5. The apparatus of claim 4, wherein the plastic is a thermoplastic or a thermosetting plastic.

6. The apparatus of claim 1, wherein the apparatus is formed at least in part by injection molding.

7. The apparatus of claim 1, wherein apparatus is operative to attach a fishing rod that has a reel.

8. The apparatus of claim 1, wherein the apparatus is operative to attach a fishing rod that does not have a reel.

9. The apparatus of claim 1, wherein the first and second pairs of opposing sidewalls in combination with the elongate base define two substantially collinear partial cylinders.

10. The apparatus of claim 9, wherein the two substantially collinear partial cylinders have inner diameters smaller than a diameter of the fishing rod.

11. The apparatus of claim 1, wherein the apparatus is adapted to apply a clamping force to at least a portion of the fishing rod when the apparatus is attaching the fishing rod to the user's person.
